(19) United States
(12) Patent Application Publication
(10) Pub. No.: US 2023/0317023 A1
(43) Pub. Date: Oct. 5, 2023

(54) LOCAL DIMMING FOR ARTIFICIAL REALITY SYSTEMS

(71) Applicant: META PLATFORMS TECHNOLOGIES, LLC, Menlo Park, CA (US)

(72) Inventors: Weihua Gao, Santa Clara, CA (US); Jianru Shi, Union City, CA (US); Tianxin Ning, San Mateo, CA (US); Haomiao Jiang, Cupertino, CA (US)

(21) Appl. No.: 17/713,965

(22) Filed: Apr. 5, 2022

(51) Int. Cl. G09G 3/34

(52) U.S. Cl. CPC G09G 3/342; G09G 2340/0407; G09G 2320/0626; G09G 2320/0247

(57) ABSTRACT

In particular embodiments, a computing system may receive an image to be shown on a display having a plurality of backlight zones. The computing system may compute a backlight matrix for adjusting brightness levels of the backlight zones of the display by computing, for each of the backlight zones, a zone statistic to represent grayscale levels of a portion of the image within the backlight zone, mapping the zone statistic of each of the backlight zones to a brightness value using a particular mapping technique configured to adjust any of the backlight zones having a zone statistic that is below a predetermined threshold, and generating the backlight matrix by filtering the brightness values. The computing system may instruct the display to output the image and adjust the backlight zones based on the backlight matrix.

### TECHNICAL FIELD

This disclosure generally relates to local dimming. In particular, the disclosure relates to an improved local dimming technique for performing local dimming in artificial reality systems, such as virtual reality (VR) headsets.

### BACKGROUND

Behind the screen of liquid crystal displays (LCD) (e.g., an LCD TV), there are small lights (e.g., backlight LEDs) that produce a lot of light. As a result, the television displays a bright image. The disadvantage, however, is that the dark parts of the screen are also illuminated because of which black images appear rather dark gray and are not true black. Local dimming (LD) is a solution to mitigate this problem. LD is a technology for liquid crystal displays (LCD) to increase contrast ratio and improve visual quality. It controls and modulates the LC transmittance with backlight brightness to properly present content with high contrast. The LD technology ensures that the lights (e.g., backlight LEDs) with which the content is displayed are dimmed or completely turned off at specific moments so that a dark scene looks correct and black colors appear true black instead of gray.

In the existing or conventional approaches for local dimming, red (R), green (G), and blue (B) (collectively herein referred to as RGB) information is provided by a graphics source, and a dedicated hardware (e.g., dedicated ASIC) computes a dimming or backlight matrix. The backlight matrix is then fed back to the graphics source so that the source may adjust the RGB for local dimming. An image may then be displayed based on the adjusted RGB and backlight intensity represented by the backlight matrix. The feedback loop (i.e., sending the backlight matrix back to the graphics source), however, introduces latency. Also, the RGB color adjustment consumes too much power. Performing such local dimming in artificial reality space is challenging.

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in artificial reality and/or used in (e.g., perform activities in) an artificial reality. Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers.

Performing local dimming in artificial reality space is challenging as artificial reality systems (e.g., VR headsets) do not have a dedicated hardware for computing the backlight matrix, and therefore the computation needs to be performed by the standard system's central processing unit (CPU). Additionally, low/no latency is an important factor when displaying content through these systems. Therefore, an improved LD solution is needed, especially for VR headset displays, that can perform LD with low latency and power requirements.

### SUMMARY OF PARTICULAR EMBODIMENTS

Embodiments described herein relate to an improved local dimming (LD) solution or technique that computes a backlight matrix for local dimming without adjusting color values of color components (e.g., RGB) of an image frame. Specifically, the improved LD solution is an improved LD algorithm that computes the backlight matrix without needing a specialized or dedicated hardware (e.g., a dedicated ASIC) as required in a conventional or traditional pipeline for local dimming. The improved LD algorithm eliminates the feedback loop (e.g., sending the computed backlight matrix back to a graphics rendering source for RGB adjustments) of the conventional pipeline. Due to the elimination of the feedback loop, there is considerably low or no latency when displaying content, especially through AR/VR headsets. Furthermore, since the improved LD algorithm eliminates RGB adjustments and need for additional hardware (e.g., dedicated ASIC) for the backlight computation, overall computational and/or power requirements are considerably reduced.

In particular embodiments, the improved LD algorithm discussed herein may compute the backlight matrix for local dimming using a series of steps. These steps may be performed on a standard CPU or system on a chip (SoC) of a display system, such as VR headset. In the first step, the LD algorithm may generate a mipmap of a received image frame (e.g., RGB frame) by downscaling the frame to a smaller resolution for efficient processing. In the second step, the LD algorithm may compute a stable zone statistic for each backlight zone to represent a grayscale level of a portion of the image within that backlight zone. In other words, the LD algorithm may compute how bright each backlight zone is based on the RGB values of pixels within that zone. In the third step, the LD algorithm may map the computed zone statistics to brightness values using a particular technique (e.g., using a custom-built lookup table). In this step, the LD algorithm may only dim the backlight zones whose grayscale levels are low/dark or are below a certain threshold. Medium and high grayscale levels are not adjusted. Since the LD algorithm does not adjust the backlight of medium grayscales, the RGB does not need to be adjusted, as the case in the traditional or conventional pipeline for local dimming. The mapping step results in an initial backlight matrix, which includes an array of brightness and/or dimming values corresponding to a plurality of backlight zones. In the last or fourth step, the LD algorithm may perform spatial-temporal filtering to minimize one or more artifacts in the initial backlight matrix to generate a final backlight matrix. These artifacts may include, for example, halo effects, over-dimming artifacts, backlight flickering artifacts due to head motion or moving objects, etc.

In particular embodiments, responsive to obtaining the final backlight matrix after the last step of the LD algorithm, a LD driver may adjust a backlight intensity or the brightness levels of the backlight zones with which to display the image frame (e.g., RGB frame) based on the brightness values in the final backlight matrix. Finally, the image frame may be displayed based on the original RGB and the backlight levels represented by the backlight matrix. In some embodiments, the image frame may be presented on an artificial reality system, such as an AR/VR headset.

The improved LD pipeline or algorithm for local dimming discussed herein is advantageous from the conventional pipeline in several aspects. By way of examples and without limitation, (1) there is no need for a dedicated hardware component (e.g., dedicated ASIC) for computing the backlight matrix; (2) since there is no specialized hardware requirement and the way by which the backlight matrix is computed, the overall computational load on the system is light as compared to the heavy computation load that is often put on the existing display systems with the conventional pipeline; (3) even without having the dedicated ASIC for computing the backlight matrix, the improved LD algorithm discussed herein may be able to achieve same or similar results (e.g., high contrast, improved visual quality, etc.) like the conventional pipeline; (4) since there is no feedback needed from the improved LD algorithm back to the graphics rendering source for the adjustment of RGB, there is considerably low or even no latency as compared to large latency (e.g., 1 frame latency) present in the conventional pipeline; (5) the visual quality produced through the improved pipeline is optimized for VR displays (e.g., with short persistence, fixed viewing angle, etc.) in contrast to the conventional pipeline that is more suited for general consumer displays (e.g., televisions). Additionally, since the improved LD algorithm in the pipeline is optimized for VR displays, backlight flickering artifacts that occur due to head motion and/or moving objects may be significantly reduced.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a conventional pipeline for performing local dimming by existing display systems.

FIG. 1B illustrates an improved pipeline for performing local dimming, in accordance with particular embodiments.

FIG. 2 is a block diagram illustrating operations performed by computing components of a display system at various stages in the improved pipeline for local dimming, in accordance with particular embodiments.

FIG. 3 is another block diagram illustrating operations performed by the computing components of the display system at various stages in the improved pipeline for local dimming, in accordance with particular embodiments.

FIG. 4 is an example graph illustrating relationship between grayscale and brightness levels before and after local dimming.

FIG. 5 illustrates an example method for local dimming, in accordance with particular embodiments.

FIG. 6 illustrates an example of a display system.

FIG. 7 illustrates an example network environment associated with a social-networking system, an augmented reality, or a virtual-reality system.

FIG. 8 illustrates an example computer system.

### DESCRIPTION OF EXAMPLE EMBODIMENTS

Local dimming (LD) is a technology for liquid crystal displays (LCD) to increase contrast ratio and improve visual quality. It controls and modulates the LC transmittance with backlight brightness to properly present content with high contrast. The LD technology ensures that the lights (e.g., backlight LEDs) with which the content is displayed are dimmed or completely turned off at specific moments so that a dark scene looks correct and black colors appear true black instead of gray. By way of an example and not limitation, imagine a picture of a bright moon at night. The bright light from the moon oftentimes bleads into the surrounding dark regions due to which the black area representing the sky at night appears rather gray or have what is known as a blooming/halo effect. In order to correct these defects, local dimming is required so that the bright moon and the black sky are shown in their true colors.

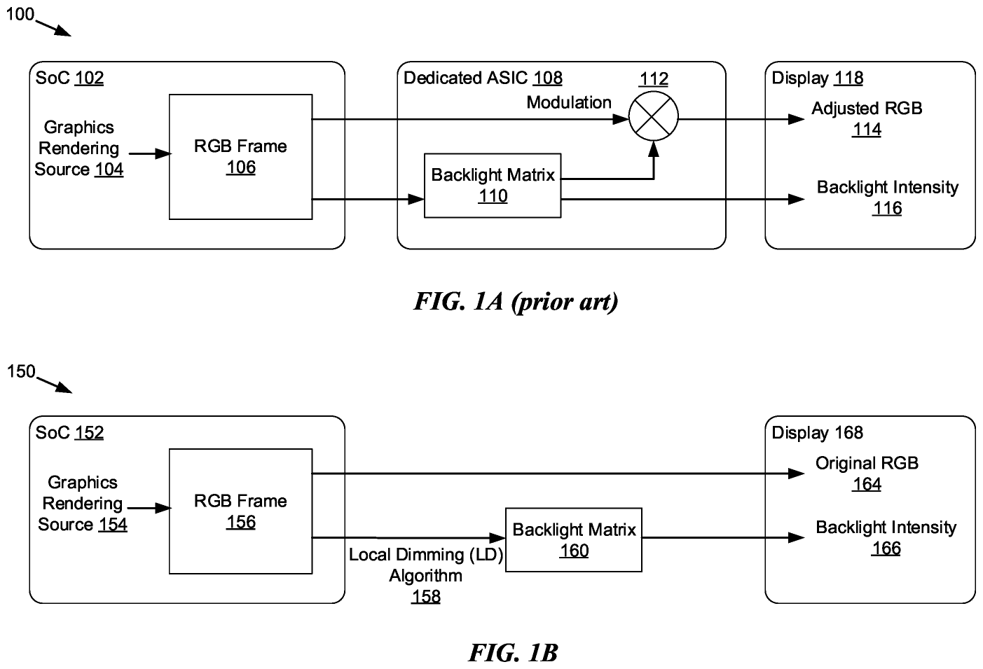

FIG. 1A illustrates a conventional pipeline 100 for performing local dimming by existing display systems. As depicted, a graphics rendering source/engine 104 of a system on a chip (SoC) 102 (e.g., essential computer components on a single chip) running on a display system may render display information, such as a sequence of image frames (e.g., a video). Each image frame may include a plurality of pixels and each pixel may correspond to a plurality of color components. Specifically, the plurality of color components may include three color components, including red (R), green (G), and blue (B) (collectively herein referred to as RGB). In particular embodiments, the image frame may be a composition or summation of the plurality of pixels and RGB values associated with each of the pixels. Herein, the terms “image”, “image frame”, and “RGB frame” may be used interchangeably throughout this disclosure.

The graphics rendering source 104 may provide a RGB frame 106 to a dedicated application-specific integrated circuit (ASIC) chip 108. The ASIC chip 108 may be configured for a particular use or to perform a specific operation, such as computing a backlight matrix 110 and then modulation 112 of RGB color values in the RGB frame 106 based on the computed backlight matrix 110. The adjusted/modulated RGB 114 and backlight intensity 116 represented by the backlight matrix 110 are then used to instruct a display 118 to output an image.

However, there are certain limitations or drawbacks associated with the conventional pipeline 100 for performing local dimming. First, a dedicated hardware, such as dedicated ASIC 108, is needed to compute the backlight matrix 110. This increases computational requirement for resource-constrained devices (e.g., devices with limited hardware or power), especially for artificial reality systems (e.g., VR headsets). Second, the computed backlight matrix 110 is needed to be sent back to the graphics rendering source 104 for the modulation 112 of the RGB color values in the RGB frame 106. This feedback loop (i.e., sending the backlight matrix back to the graphics rendering source 104), however, introduces latency. The latency is fine when displaying content through televisions or projectors. However, one cannot afford this latency when displaying content through latency-sensitive devices (e.g., AR/VR headsets) since real-time information needs to be presented to a user as the user is looking though their surroundings or environment. Third, the modulation step 112 (i.e., RGB color adjustment) consumes too much power, which again puts on a bottleneck on the resource-constrained devices (e.g., devices with limited hardware or power), especially for VR headsets. Due to these limitations or drawbacks with the conventional pipeline 100, an improved local dimming technique or solution is needed to perform local dimming, especially in the AR/VR space. Specifically, an improved local dimming algorithm is needed that can perform local dimming for VR headset displays without adding extra latency, computational, and/or power requirements of the conventional pipeline 100.

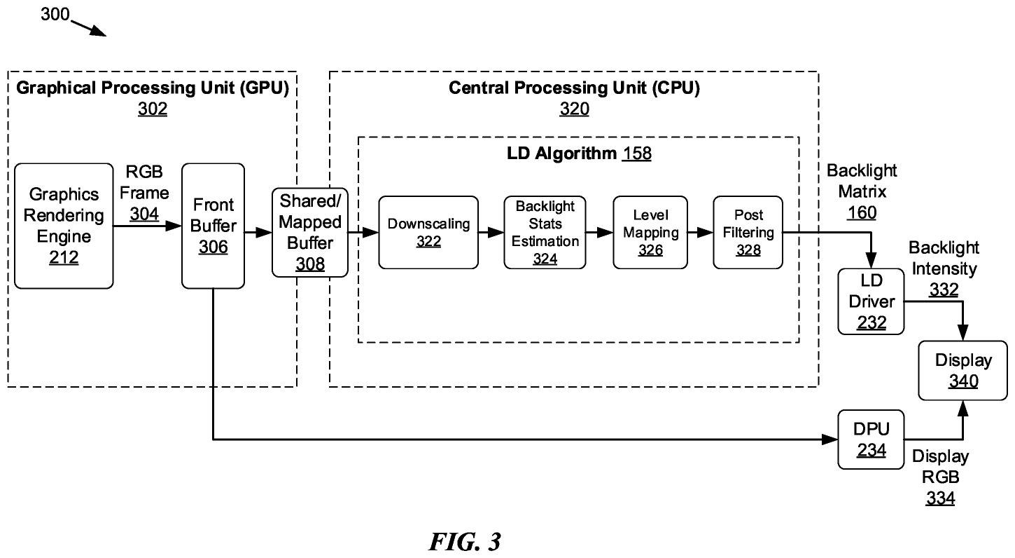

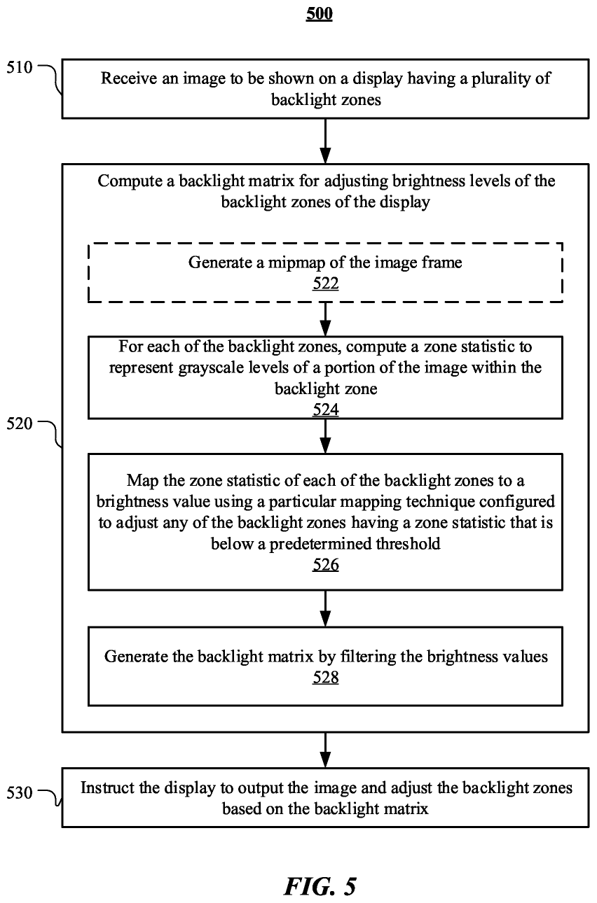

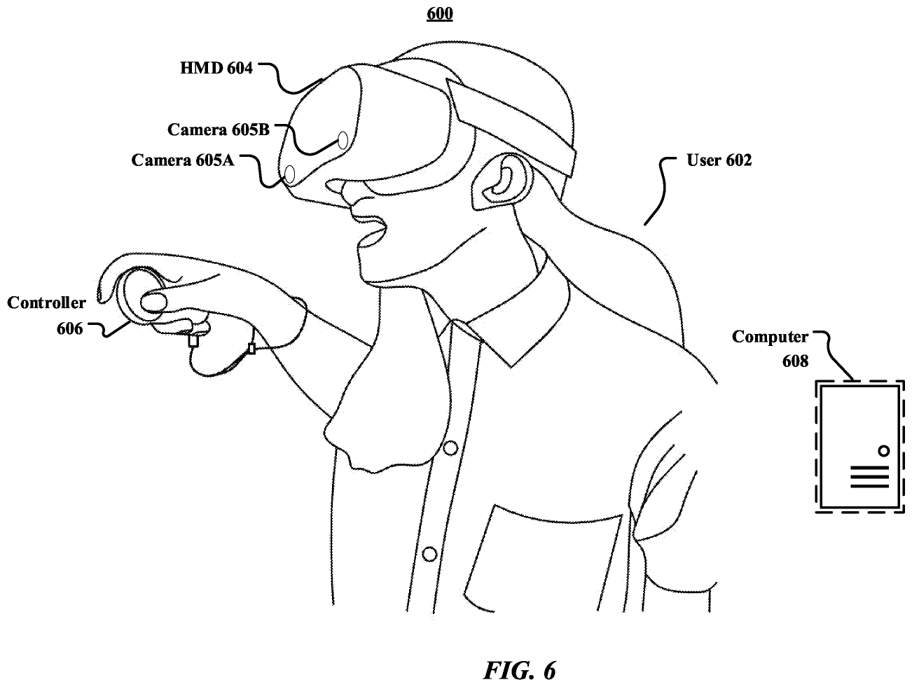

FIG. 1B illustrates an improved pipeline 150 for performing local dimming. In particular, the improved pipeline 150 illustrates high-level steps that may be performed by artificial reality systems (e.g., AR/VR headsets) to achieve local dimming. Similar to the conventional pipeline 100, a graphics rendering source/engine 154 of a SoC 152 running on an artificial reality system (e.g., artificial reality system 600 shown in FIG. 6) may provide display information. The display information may include RGB information, in particular a RGB frame 156. Based on the RGB frame 156, an improved local dimming or backlight algorithm 158 computes a backlight matrix 160. The improved local dimming algorithm 158 may be running on the same SoC chip 152 for the computation of the backlight matrix 160. It should be noted that the backlight matrix 160 computed here is different from the backlight matrix 110 computed by the LD/backlight algorithm in the conventional pipeline 100. For instance, the backlight matrix 160 may include data/information that is sufficient enough to perform the local dimming without needing to perform the modulation 112 (i.e., adjust the RGB), as the case in the conventional local dimming pipeline 100. In particular embodiments, the LD algorithm 158 may compute the backlight matrix 160 based on steps illustrated in FIG. 3 or FIG. 5. Once the backlight matrix 160 is computed, backlight intensity 166 represented by the backlight matrix 160 and original RGB 164 of the RGB frame 156 may be used to instruct a display 168 to output an image. The image may be presented to a user wearing the artificial reality system, such as the artificial reality system 600 shown in FIG. 6.

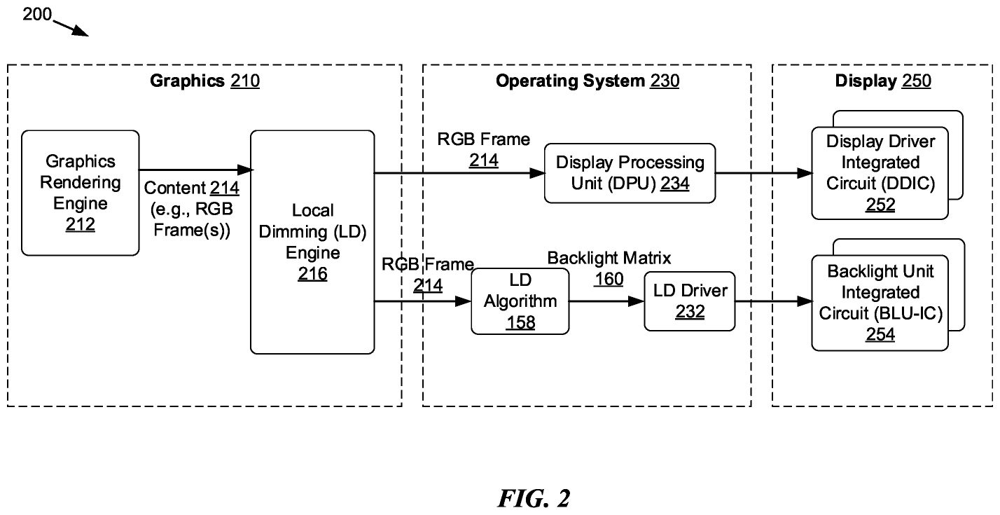

The improved pipeline 150 for local dimming is advantageous from the conventional pipeline 100 in several aspects. By way of examples and without limitation, (1) there is no need for a dedicated hardware component (e.g., dedicated ASIC) for computing the backlight matrix; (2) since there is no specialized hardware requirement and the way by which the backlight matrix 160 is computed (as discussed later below in FIG. 3 or FIG. 5), the overall computational load on the system is light as compared to the heavy computation load that is often put on the existing display systems with the conventional pipeline 100; (3) even without having the dedicated ASIC 108 for computing the backlight matrix, the improved LD algorithm discussed herein may be able to achieve same or similar results (e.g., high contrast, improved visual quality, etc.) like the conventional pipeline 100; (4) since there is no feedback needed from the improved LD algorithm 158 back to the graphics rendering source for the adjustment of RGB (e.g., modulation 112), there is considerably low or even no latency as compared to large latency (e.g., 1 frame latency) present in the conventional pipeline 100; (5) the visual quality produced through the improved pipeline 150 is optimized for VR displays (e.g., with short persistence, fixed viewing angle, etc.) in contrast to the conventional pipeline 100 that is more suited for general consumer displays (e.g., televisions). Additionally, since the improved LD algorithm in the pipeline 150 is optimized for VR displays, backlight flickering artifacts that occur due to head motion and/or moving objects may be significantly reduced. The improved pipeline 150 for local dimming is further discussed below with respect to FIG. 2.

FIG. 2 is a block diagram 200 illustrating operations performed by computing components of a display system at various stages in the improved pipeline for local dimming. In particular, the block diagram 200 illustrates operations performed by the computing components of an artificial reality system (e.g., artificial reality system 600 of FIG. 6) at its graphics side 210, operating system (OS) kernel side 230, and display side 250. It should be noted that some of the reference numerals have been kept same throughout this disclosure for consistency, ease of understanding, and to refer to the same entities, components, and/or elements that have already been discussed. However, the entities, components, and/or elements represented by these same reference numerals are not by any way limited to the scope or functionality discussed earlier and may encompass additional scope or functionality.

At the graphics side 210, a graphics rendering engine (e.g., a VrRuntime engine) 212 may receive content 214 (e.g., VR/AR content) and send the content 214 to the LD engine 216. For instance, the graphics rendering engine 212 may receive the content 214 from one or more cameras of the display system (e.g., VR headset) worn by a user, where the cameras may be configured to capture the physical environment around the user and may do so continuously to generate the content comprising of one or more RGB frames 214. Each RGB frame may include a plurality of pixels. In particular embodiments, the RGB frame 214 may be a composition or summation of the plurality of pixels and RGB values associated with each of the pixels. In response to receiving a RGB frame 214 from the graphics rendering engine 212, the LD engine 216, in cooperation and/or communication with the system's CPU (e.g., CPU 320 as shown in FIG. 3), may process the RGB frame 214 to compute a backlight matrix 160, as discussed in further detail below.

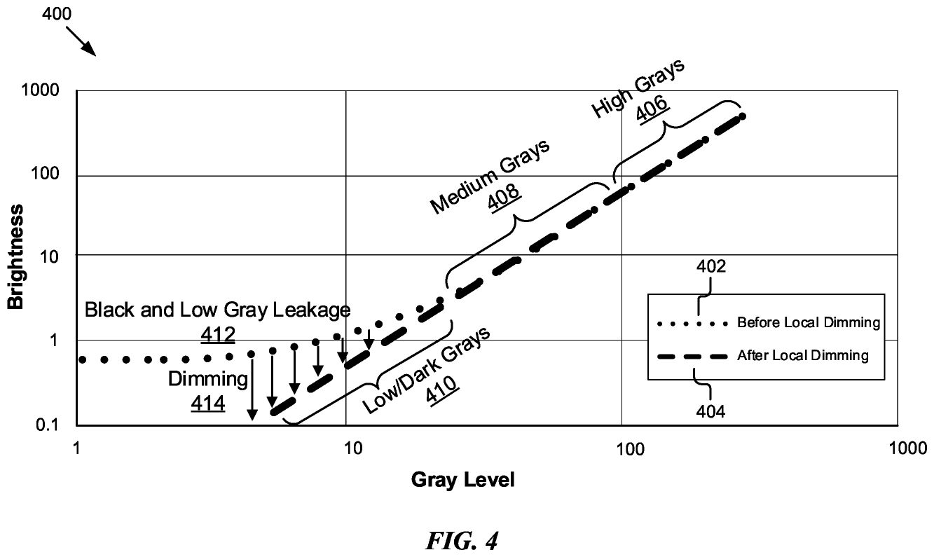

At the OS kernel side 230, the CPU (e.g., CPU 320) of the display system runs the LD algorithm 158 to compute the backlight matrix 160. In particular embodiments, the LD algorithm 158 may compute the backlight matrix 160 based on a 4-step procedure shown and discussed below in reference to FIG. 3. The backlight matrix 160 may be an array of brightness and/or dimming values corresponding to a plurality of backlight zones. Each backlight zone may encompass a subset of pixels of the plurality of pixels of the RGB frame 214. At a high level, the backlight matrix 160 may indicate by what amount (e.g., percentage) each backlight zone should be lit or dimmed to present the content 214. In particular embodiments, each backlight zone may be lit or dimmed by a corresponding light source (e.g., LEDs). Based on the backlight matrix 160, an LD driver 232 may adjust a backlight intensity (e.g., brightness levels) of one or more LEDs of a display component. In some embodiments, adjusting the backlight intensity may include the LD driver 232 turning on/off a subset of LEDs in the display component. In particular embodiments, adjustment the backlight intensity may include the LD driver 232 dimming a brightness level of the subset of LEDs corresponding to low/dark gray level regions of the content 214, as shown and discussed in further detail below in reference to FIG. 4. In particular embodiments, the computation of the backlight matrix 160 by the LD algorithm 158 and then adjustment of the backlight intensity by the LD driver 232 happens very fast such that there is no latency or very low latency introduced into the system through these steps.

In some embodiments, in addition to computing the backlight matrix 160, a display processing unit (DPU) may receive the original RGB frame 214 and may perform one or more post-processing steps on the original RGB frame 214 to remove one or more artifacts or further improve image quality. It should be noted that the post-processing steps performed by the DPU 234 are not related to the local dimming discussed herein and these steps may only be performed to correct some artifacts resulting from certain components (e.g., optics, lens) of the display system. As an example and without limitation, an image may be distorted due to lens distortions or chromatic aberrations resulting from light passing through optics (e.g., lens) of the VR headset and therefore, the DPU 234 may perform one or more post-processing steps on the RGB frame 214 to correct these lens distortions or effects of chromatic aberrations.

In particular embodiments, the LD driver 232 and the DPU 234 may communicate and/or cooperate with each other to ensure that the outputs produced by the LD driver 232 and the DPU 234 are synchronized with each other for every frame. In one embodiment, the LD driver 232 may synchronize the backlight intensity with an output of the DPU 234 (e.g., RGB frame after correcting lens distortions or chromatic aberrations) so that the backlight and the RGB frame are synchronized when a display is generated. In another embodiment, the DPU 234 may synchronize its output with an output of the LD driver 232 to ensure that the backlight and RGB are synchronized for every frame. In particular embodiments, the DPU 234 may be configured to control the timing and communication between the SoC (e.g., GPU, CPU) and a display component of the system.

At the display side 250, a set of integrated circuits (ICs) may be configured to generate a display or output an image based on the RGB frame output by the DPU 234 and the backlight intensity output by the LD driver 232. For instance, one or more display driver ICs (DDIC) 252 may be configured to control display panel(s) and produce a rich and vibrant display based on the RGB output by the DPU 234. In particular embodiments, a DDIC 252 may receive the RGB information from the DPU 234 via a communication layer or interface, such as C-PHY. One or more backlight unit ICs (BLU-IC) 254 may be configured to control the backlight based on the backlight intensity output by the LD driver 232. In particular embodiments, a BLU-IC 254 may receive the backlight intensity information from the LD driver 232 via a communication interface/bus, such as a serial peripheral interface (SPI). In some embodiments, the resulting display or image (i.e., RGB+backlight) may be presented on a screen of the display system. As an example and not by way of limitation, the resulting image may be presented on a VR headset's display.

FIG. 3 is another block diagram 300 illustrating operations performed by the computing components of the display system at various stages in the improved pipeline for local dimming. In particular, the block diagram 300 illustrates operations performed by the GPU 302 and the CPU 320 components of the display system, such as the artificial reality system 600 shown in FIG. 6. Additionally, the block diagram 300 illustrates steps performed by the LD algorithm 158 for computing the backlight matrix 160 discussed herein. It should again be noted that some of the reference numerals have been kept same throughout this disclosure merely for consistency, ease of understanding, and to refer to the same entities, components, and/or elements that have already been discussed. However, this is not by anyway limiting and these entities, components, and/or elements represented by the same reference numerals may include additional scope or functionalities.

As discussed elsewhere herein, the graphics rendering engine 212 of the GPU 302 of the display system may receive a RGB frame 304 (e.g., RGB frame 214) from a particular source, such as a front-facing camera of the VR headset. The graphics rendering engine 212 may store the RGB frame 304 in a front buffer 306. In particular embodiments, the front buffer 306 may be a dedicated memory or storage allocated to the GPU 302 for storing graphical content (e.g., images, videos, audio, frames, etc.). In order for the GPU 302 to share some portion of the graphical content with the CPU 320 for it to process, the GPU 302 may store the portion in a shared or mapped buffer 308. For instance, the GPU 302 may transfer the RGB frame 304 from the front buffer 306 to the shared buffer 308 so that the CPU 320 may be able to process the RGB frame 304 to compute the backlight matrix 160 discussed herein.

In particular embodiments, the LD algorithm 158 may receive the RGB frame 304 from the shared or mapped buffer 308 and perform a series of steps 322, 324, 326, and 328 in sequence to compute the backlight matrix 160. In the first step 322, the LD algorithm 158 may generate a mipmap of the RGB frame 304. In some embodiments, generating the mipmap may include downscaling the resolution of the RGB frame 304 to a reduced resolution for efficient processing. For instance, the input resolution, especially in VR, is significantly high and since there is no dedicated/specialized hardware (e.g., dedicated ASIC 108) for computing the backlighting like the traditional displays, the input resolution needs to be downscaled to a smaller resolution so that the RGB frame 304 may be processed with the CPU 320. As an example and not by way of limitation, the LD algorithm 158 may use 10× downscaling or 8× (e.g., 3 level) mip downsize to downscale the RGB frame 304. In some embodiments, the value of downscaling may depend upon RGB resolution and number of backlight zones.

In the second step 324, the LD algorithm 158 may compute a zone statistic (also interchangeably referred to herein as BLU stats) for each backlight zone to represent a grayscale level of a portion of the image within that backlight zone. In other words, the LD algorithm 158 may compute how bright a particular backlight zone is based on the RGB values of pixels within that zone. As mentioned earlier, each backlight zone may encompass a subset of pixels of the RGB frame 304. As an example and not by way of limitation, a backlight zone may encompass 100 pixels out of 1000 pixels that make up the RGB frame 304. In particular embodiments, the LD algorithm 158 may compute the BLU stats for a backlight zone by first averaging values of each of the RGB channels or color components across the pixels within the backlight zone and then taking a max value of the averaged RGB. Continuing the same 100 pixels example within the backlight zone, the LD algorithm 158 may compute an average R value by taking an average of the red value across the 100 pixels, an average G value by taking an average of the green value across the 100 pixels, and an average B value by taking an average of the blue value across the 100 pixels. In this example, let's assume the average R value comes out to 10, the average G value comes out to 15, and the average B value comes out to 75, then the LD algorithm takes the max value i.e., 75 as the statistic or BLU stat for the particular backlight zone. Similarly, the LD algorithm 158 may estimate the BLU stats for other backlight zones. In particular embodiments, the LD algorithm 158 estimates these BLU stats for the backlight zones so that a particular color may be displayed with its intended brightness and only those backlight zones whose BLU stats are equal to or lower than a certain threshold may be dimmed, as discussed in further detail below in step 326 and shown in FIG. 4. For example, if there is a bright blue in a scene (e.g., represented by the RGB frame 304), then that bright blue should be displayed as is without any adjustment.

In the third step 326, the LD algorithm 158 may perform level mapping, which including mapping the zone statistics computed in step 324, for each backlight zone, to a brightness and/or dimming value using a particular technique. In particular embodiments, the LD algorithm 158 may use a custom-built lookup table to map the statistics or BLU stats to a brightness value. For instance, the lookup table may include predetermined brightness and/or dimming values corresponding to different BLU stats (e.g., max values) and the LD algorithm 158 may use this data to map each of the statistic or BLU stat associated with a backlight zone to a corresponding brightness/dimming value indicated in the lookup table. In some embodiments, the LD algorithm 158 may also perform the level mapping 326 using a machine learning (ML) technique. For instance, a trained ML model may output brightness and/or dimming values corresponding to specific statistics/BLU stats. The ML model may be trained based on ground-truth statistics and their corresponding ground-truth brightness and/or dimming values.

In particular embodiments, during the level mapping operation, the LD algorithm 158 may use a gamma curve for low brightness zones (e.g., zones with low/dark gray levels as shown in FIG. 4) and saturate at certain threshold (e.g., max value less than or equal to 20). Stated differently, the LD algorithm 158 may find backlight zones whose max value is less than the certain threshold and only dim those zones to a particular brightness value using the lookup table. For instance, the backlight zones corresponding to dark or low gray levels in the RGB frame 304 may be dimmed by their corresponding brightness/dimming values in the lookup table, whereas medium and high gray levels may be left untouched or unadjusted. This is further shown and discussed later below in reference to FIG. 4. Since the LD algorithm 158 does not adjust the backlight of medium and/or high grayscales, the RGB does not need to be adjusted in the case of the improved pipeline 150 for local dimming. In the conventional pipeline 100, both the low and medium grayscales are adjusted. Since the medium gray levels are adjusted, the visual scene depicted by a RGB frame may not look right and therefore the RGB color values needs to be adjusted or modulated, as discussed above in reference to FIG. 1A.

The backlight stats estimation 324 and level mapping 326 steps are now further described by way of a following non-limiting example. Assume that the RGB frame 304 depicts an image of golden gate bridge taken at night. In the backlight stats estimation step 324, the LD algorithm 158 may estimate, for a first set of backlight zones, a high max value (e.g., high R value) due to these zones representing the golden gate bridge. The LD algorithm 158 may estimate, for a second set of backlight zones, a very low max value due to these zones representing the black or dark sky. Responsive to estimating these max values, then in the level mapping step 326, the LD algorithm 158 may adjust the brightness of only the second set of backlight zones having very low max value (e.g., dark/black portions of the image). For instance, the LD algorithm 158 may set the brightness/dimming value for one or more second backlight zones to a low value (e.g., 0.1 or 1% brightness). Whereas for the first set of backlight zones representing the golden gate bridge, the LD algorithm 158 may map the BLU stats for these zones to a full brightness level (e.g., 100 or 100% brightness) or a brightness level as originally intended without any adjustment.

In particular embodiment, the level mapping step 326 may output an initial backlight matrix, which may include an array of brightness and/or dimming values corresponding to a plurality of backlight zones. At a high level, the backlight matrix may indicate by what amount (e.g., percentage) each backlight zone should be lit or dimmed by the LD driver 232. Using the brightness and/or dimming values in the backlight matrix, the LD driver 232 may adjust the backlight intensity accordingly to perform the local dimming, as discussed elsewhere herein. However, simply displaying based on the backlight matrix produced after the level mapping 326 may be prone to some artifacts. These artifacts may include, for example and without limitation, backlight flickering artifacts due to head motion or moving objects in VR, over-dimming artifacts, and halo effects (e.g., light falling into darker areas surrounding an object, such as area around a bright moon that should actually be dark).

In the fourth or last step 328, the LD algorithm 158 may perform post filtering on the initial backlight matrix produced after the level mapping step 326 in order to correct one or more artifacts discussed above. In particular embodiments, the post filtering 328 may include the LD algorithm 158 spatially as well as temporally filtering or smoothening the brightness values in the initial backlight matrix to minimize the one or more artifacts. As an example and not by way of limitation, the LD algorithm 158 may perform the spatial filtering by using a spatial dilation and/or gaussian blur to minimize halo and over-dimming artifacts in the initial backlight matrix. The LD algorithm 158 may perform the temporal filtering by using recursive temporal averaging to remove backlight flickering artifacts occurring due to head motion or moving objects, especially in VR.

Responsive to performing the last step i.e., post filtering 328 (e.g., spatial-temporal filtering), the LD algorithm 158 generates a final backlight matrix 160. As discussed elsewhere herein, based on the backlight matrix 160, the LD driver 232 may adjust a backlight intensity 332 of one or more LEDs of a display component. In some embodiments, adjusting the backlight intensity 332 may include the LD driver 232 turning on/off a subset of LEDs in the display component. In particular embodiments, adjustment the backlight intensity may include the LD driver 232 dimming a brightness level of the subset of LEDs corresponding to low/dark gray level regions, as shown and discussed in further detail below in reference to FIG. 4. In particular embodiments, the LD driver 232 may adjust (e.g., turn on/off, increase/decrease backlight intensity) of the LEDs based on the brightness and/or dimming values included in the backlight matrix 160.

As discussed elsewhere herein, the DPU 234 may receive the original RGB frame 304 from the front buffer 306 and may perform one or more post-processing steps on the original RGB frame 304 to remove some additional artifacts (e.g., lens distortions, chromatic aberrations, etc.) or further improve image quality. It should again be noted that the post-processing steps performed by the DPU 234 are not related to the local dimming discussed herein and these steps may only be performed to correct some artifacts resulting from certain components (e.g., optics, lens) of the display system. The DPU 234 may output a display RGB 334. Using the backlight intensity 332 output by the LD driver 232 and the display RGB 334 output by the DPU 234, a display 340 may be instructed to output an image accordingly. As discussed elsewhere herein, the resulting image may be presented on a screen of the display system, such as the artificial reality system 600 shown in FIG. 6. As an example and not by way of limitation, the resulting image may be presented on a VR headset's display.

FIG. 4 is an example graph 400 illustrating relationship between grayscale and brightness levels before and after local dimming. In particular, the graph 400 shows different gray levels and their corresponding example brightness levels before the local dimming (e.g., indicated by dotted line 402) and after the local dimming discussed herein (e.g., indicated by dashed line 404). Specifically, the graph 400 shows three gray levels, including high grays 406, medium grays 408, and low/dark grays 410. As depicted, the high grays 406 falls into 100-1000 brightness level, the medium grays 408 falls into 5-100 brightness level, and low/dark grays 410 in 0-5 brightness level. It should be noted that this categorization of gray levels to brightness levels is merely by way of example and for understanding purposes only. The actual numbers or brightness levels may be different for each of these gray levels 406, 408, and 410. Usually in the low gray levels 410 (e.g., dark regions in an image), there is black and low gray leakage 412 due to which black color appears to be washed out or rather grey than true black. Because of this black and low gray leakage 412, local dimming 414 is required. The local dimming 414 may be performed according to the improved pipeline 150 and specifically, using the LD algorithm 158 and its corresponding steps 322-328 discussed herein. As depicted in this figure and discussed earlier, backlight zones corresponding to dark or low gray levels 410 in an RGB frame may be dimmed by their corresponding brightness/dimming values using a lookup table. The medium grays 408 and high grays 406 are left untouched or unadjusted. Since the LD algorithm 158 does not adjust the backlight of medium 408 and/or high grayscales 406, the RGB does not need to be adjusted in the case of the improved pipeline 150 for local dimming. In the conventional pipeline 100, however, both the low 410 and medium 408 grayscales are adjusted. Since the medium gray levels 408 are adjusted, the visual scene depicted by a RGB frame may not look right and therefore the RGB color values needs to be adjusted or modulated, as discussed above in reference to FIG. 1A.

FIG. 5 illustrates an example method 500 for local dimming, in accordance with particular embodiments. The method may begin at step 510, where a computing system may receive an image or an image frame to be shown on a display having a plurality of backlight zones. The image may include a plurality of color components, such as RGB color components or channels. At step 520, the computing system may compute a backlight matrix for adjusting brightness levels of the backlight zones of the display in order to perform local dimming of the display, as discussed elsewhere herein. In particular embodiments, the backlight matrix (e.g., backlight matrix 160) may be computed by a local dimming algorithm (e.g., local dimming algorithm 158) running on a CPU (e.g., CPU 320) of the computing system. The backlight matrix may be computed without needing a specialized/dedicated hardware (e.g., dedicated ASIC) as in the case of the conventional pipeline 100 for local dimming.

In particular embodiments, the computing system may compute the backlight matrix based on a 4-step procedure, as discussed in FIG. 3. For instance, in the first step 522 or 322, the computing system may generate a mipmap of the image frame. In some embodiments, generating the mipmap may include downscaling the image frame to a reduced resolution for efficient processing. It should be noted that the first step 522 or 322 is shown with a dotted line to indicate that step 522 or 322 may be optional, and the computing system may, in some instances, directly proceed to or begin with step 524 to compute the backlight matrix discussed herein. In the second step 524 or 324, the computing system may compute, for each backlight zone, a zone statistic or BLU stat to represent grayscale levels of a portion of the image within the backlight zone. In some embodiments, the computing system may compute the zone statistic for a particular backlight zone by computing, for each color component (e.g., of the RGB), an average value of the color component across a plurality of pixels within the backlight zone, determining a maximum value among average values of the plurality of color components, and assigning the maximum value to the backlight zone to represent the grayscale levels of the portion of the image within that zone. In the third step 526 or 326, the computing system may map the zone statistic, of each backlight zone, to a brightness or dimming value using a particular mapping technique that is configured to adjust any of the backlight zones having a zone statistic that is below a predetermined threshold. In some embodiments, the mapping may include determining backlight zones with zone statistics less than or equal to a predetermined threshold (e.g., corresponding to low or dark grayscale levels) and dimming the brightness levels of the determined backlight zones using the particular mapping technique. In some embodiments, the particular mapping technique may include a lookup table comprising predetermined brightness or dimming values corresponding to different zone statistics. In other embodiments, the particular mapping technique may include a machine learning technique, as discussed elsewhere herein. The mapping step 526 or 326 may result in an initial backlight matrix comprising of brightness or dimming values for different backlight zones. However, as mentioned earlier, the initial backlight matrix resulting from the mapping step 526 may contain or prone to certain artifacts. Therefore, in the last step 528 or 328, the computing system may generate a final backlight matrix by filtering the brightness values in the initial backlight matrix. In some embodiments, generating the final backlight matrix may include performing spatial-temporal filtering to minimize one or more artifacts in the initial backlight matrix. In some embodiments, performing the spatial-temporal filtering may include temporally filtering or smoothening the brightness values in the initial backlight matrix based on a current frame and previous frames to minimize first artifacts (e.g., backlight flickering artifacts due to head motion or moving objects) and spatially filtering or smoothening the brightness values in the initial backlight matrix based on neighboring dimming zones to minimize second artifacts (e.g., over-dimming artifacts or halo effects).

In particular embodiments, responsive to obtaining the final backlight matrix after the fourth step 528 or 328 (i.e., spatial-temporal filtering), the computing system, using the LD driver 232, may adjust a backlight intensity or the brightness levels of the backlight zones of the display based on the brightness values in the final backlight matrix. The backlight intensity or the brightness levels may be adjusted or the local dimming is performed without modifying color values of the color components (e.g., RGB), as discussed elsewhere herein. At step 530, the computing system may instruct the display to output the image and adjust the backlight zones based on the final backlight matrix. In some embodiments, the display may be associated or part of an artificial reality system, such as the artificial reality system 600 shown in FIG. 6. In particular embodiments, the computing system may instruct the display to present the image to a user wearing a VR headset.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for local dimming, including the particular steps of the method of FIG. 5, this disclosure contemplates any suitable method for local dimming, including any suitable steps, which may include a subset of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

FIG. 6 illustrates an example of a display system, in particular, an artificial reality system 600 worn by a user 602. The display system or the artificial reality system 600 may be used to implement some of the embodiments/examples disclosed herein. The artificial reality system 600 may be configured to operate as a virtual reality display, an augmented reality display, and/or a mixed reality display. In particular embodiments, the artificial reality system 600 may comprise a head-mounted device (“HMD”) 604, a controller 606, and a computing system 608. The HMD 604 may be worn over the user's eyes and provide visual content (e.g., VR or AR content) to the user 602 through internal displays (not shown). The HMD 604 may have two separate internal displays, one for each eye of the user 602. As illustrated in FIG. 6, the HMD 604 may completely cover the user's field of view. By being the exclusive provider of visual information to the user 602, the HMD 604 achieves the goal of providing an immersive artificial-reality experience.

The HMD 604 may have external-facing cameras, such as the two forward-facing cameras 605A and 605B shown in FIG. 6. While only two forward-facing cameras 605A-B are shown, the HMD 604 may have any number of cameras facing any direction (e.g., an upward-facing camera to capture the ceiling or room lighting, a downward-facing camera to capture a portion of the user's face and/or body, a backward-facing camera to capture a portion of what's behind the user, and/or an internal camera for capturing the user's eye gaze for eye-tracking purposes). The external-facing cameras are configured to capture the physical environment around the user and may do so continuously to generate a sequence of frames (e.g., as a video).

The 3D representation may be generated based on depth measurements of physical objects observed by the cameras 605A-B. Depth may be measured in a variety of ways. In particular embodiments, depth may be computed based on stereo images. For example, the two forward-facing cameras 605A-B may share an overlapping field of view and be configured to capture images simultaneously. As a result, the same physical object may be captured by both cameras 605A-B at the same time. For example, a particular feature of an object may appear at one pixel P_{A} in the image captured by camera 605A, and the same feature may appear at another pixel p_{B} in the image captured by camera 605B. As long as the depth measurement system knows that the two pixels correspond to the same feature, it could use triangulation techniques to compute the depth of the observed feature. For example, based on the camera 605A's position within a 3D space and the pixel location of P_{A} relative to the camera 605A's field of view, a line could be projected from the camera 605A and through the pixel P_{A}. A similar line could be projected from the other camera 605B and through the pixel p_{B}. Since both pixels are supposed to correspond to the same physical feature, the two lines should intersect. The two intersecting lines and an imaginary line drawn between the two cameras 605A and 605B form a triangle, which could be used to compute the distance of the observed feature from either camera 605A or 605B or a point in space where the observed feature is located.

In particular embodiments, the pose (e.g., position and orientation) of the HMD 604 within the environment may be needed. For example, in order to render the appropriate display for the user 602 while he is moving about in a virtual environment, the system 600 would need to determine his position and orientation at any moment. Based on the pose of the HMD, the system 600 may further determine the viewpoint of either of the cameras 605A and 605B or either of the user's eyes. In particular embodiments, the HMD 604 may be equipped with inertial-measurement units (“IMU”). The data generated by the IMU, along with the stereo imagery captured by the external-facing cameras 605A-B, allow the system 600 to compute the pose of the HMD 604 using, for example, SLAM (simultaneous localization and mapping) or other suitable techniques.

In particular embodiments, the artificial reality system 600 may further have one or more controllers 606 that enable the user 602 to provide inputs. The controller 606 may communicate with the HMD 604 or a separate computing unit 608 via a wireless or wired connection. The controller 606 may have any number of buttons or other mechanical input mechanisms. In addition, the controller 606 may have an IMU so that the position of the controller 606 may be tracked. The controller 606 may further be tracked based on predetermined patterns on the controller. For example, the controller 606 may have several infrared LEDs or other known observable features that collectively form a predetermined pattern. Using a sensor or camera, the system 600 may be able to capture an image of the predetermined pattern on the controller. Based on the observed orientation of those patterns, the system may compute the controller's position and orientation relative to the sensor or camera.

The artificial reality system 600 may further include a computer unit 608. The computer unit may be a stand-alone unit that is physically separate from the HMD 604 or it may be integrated with the HMD 604. In embodiments where the computer 608 is a separate unit, it may be communicatively coupled to the HMD 604 via a wireless or wired link. The computer 608 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 600 depends on the capabilities of its computer unit 608.

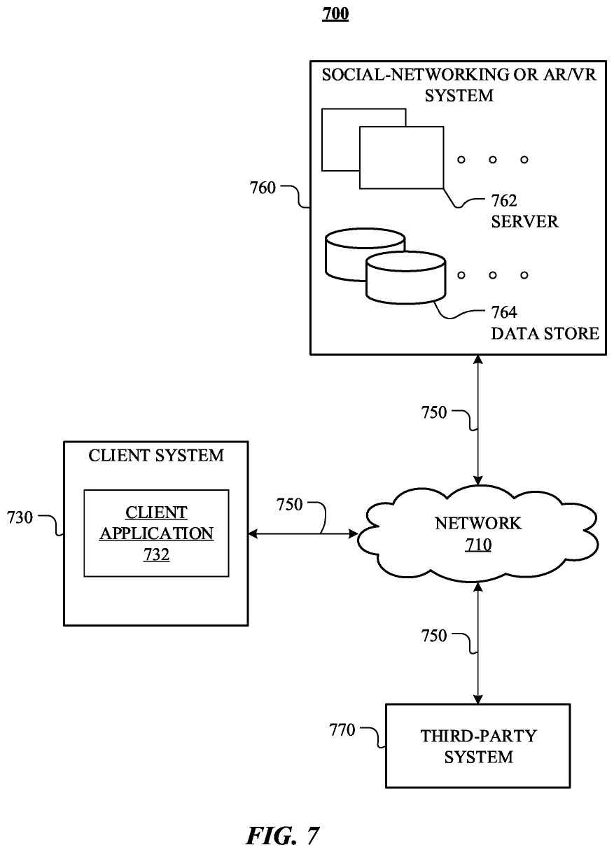

FIG. 7 illustrates an example network environment 700 associated with an augmented reality (AR)/virtual reality (VR) system or a social-networking system. Network environment 700 includes a client system 730, a VR (or AR) or social-networking system 760, and a third-party system 770 connected to each other by a network 710. Although FIG. 7 illustrates a particular arrangement of client system 730, VR or social-networking system 760, third-party system 770, and network 710, this disclosure contemplates any suitable arrangement of client system 730, AR/VR or social-networking system 760, third-party system 770, and network 710. As an example and not by way of limitation, two or more of client system 730, AR/VR or social-networking system 760, and third-party system 770 may be connected to each other directly, bypassing network 710. As another example, two or more of client system 730, AR/VR or social-networking system 760, and third-party system 770 may be physically or logically co-located with each other in whole or in part. Moreover, although FIG. 7 illustrates a particular number of client systems 730, AR/VR or social-networking systems 760, third-party systems 770, and networks 710, this disclosure contemplates any suitable number of client systems 730, AR/VR or social-networking systems 760, third-party systems 770, and networks 710. As an example and not by way of limitation, network environment 700 may include multiple client system 730, AR/VR or social-networking systems 760, third-party systems 770, and networks 710.

This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 710.

Links 750 may connect client system 730, AR/VR or social-networking system system 760, and third-party system 770 to communication network 710 or to each other. This disclosure contemplates any suitable links 750. In particular embodiments, one or more links 750 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout network environment 700. One or more first links 750 may differ in one or more respects from one or more second links 750.

In particular embodiments, client system 730 may be an electronic device including hardware, software, or embedded logic components or a combination of two or more such components and capable of carrying out the appropriate functionalities implemented or supported by client system 730. As an example and not by way of limitation, a client system 730 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 730. A client system 730 may enable a network user at client system 730 to access network 710. A client system 730 may enable its user to communicate with other users at other client systems 730.

In particular embodiments, client system 730 may include a client application 732 operable to provide various computing functionalities, services, and/or resources, and to send data to and receive data from the other entities of the network 710, such as the AR/VR or social-networking system 760 and/or the third-party system 770. For example, the client application 732 may be a social-networking application, an artificial-intelligence related application, a virtual reality application, an augmented reality application, an artificial reality or a mixed reality application, a camera application, a messaging application for messaging with users of a messaging network/system, a gaming application, an internet searching application, etc.

In particular embodiments, the client application 732 may be storable in a memory and executable by a processor of the client system 730 to render user interfaces, receive user input, send data to and receive data from one or more of the AR/VR or social-networking system 760 and the third-party system 770. The client application 732 may generate and present user interfaces to a user via a display of the client system 730.

In particular embodiments, AR/VR or social-networking system 760 may be a network-addressable computing system that can host an online Virtual Reality environment, an augmented reality environment, or social network. AR/VR or social-networking system 760 may generate, store, receive, and send social-networking data, such as, for example, user-profile data, concept-profile data, social-graph information, or other suitable data related to the online social network. Social-networking or AR/VR system 760 may be accessed by the other components of network environment 700 either directly or via network 710. As an example and not by way of limitation, client system 730 may access social-networking or AR/VR system 760 using a web browser, or a native application associated with social-networking or AR/VR system 760 (e.g., a mobile social-networking application, a messaging application, another suitable application, or any combination thereof) either directly or via network 710. In particular embodiments, social-networking or AR/VR system 760 may include one or more servers 762. Each server 762 may be a unitary server or a distributed server spanning multiple computers or multiple datacenters. Servers 762 may be of various types, such as, for example and without limitation, a mapping server, web server, news server, mail server, message server, advertising server, file server, application server, exchange server, database server, proxy server, another server suitable for performing functions or processes described herein, or any combination thereof. In particular embodiments, each server 762 may include hardware, software, or embedded logic components or a combination of two or more such components for carrying out the appropriate functionalities implemented or supported by server 762. In particular embodiments, social-networking or AR/VR system 760 may include one or more data stores 764. Data stores 764 may be used to store various types of information. In particular embodiments, the information stored in data stores 764 may be organized according to specific data structures. In particular embodiments, each data store 764 may be a relational, columnar, correlation, or other suitable database. Although this disclosure describes or illustrates particular types of databases, this disclosure contemplates any suitable types of databases. Particular embodiments may provide interfaces that enable a client system 730, a social-networking or AR/VR system 760, or a third-party system 770 to manage, retrieve, modify, add, or delete, the information stored in data store 764.

In particular embodiments, social-networking or AR/VR system 760 may store one or more social graphs in one or more data stores 764. In particular embodiments, a social graph may include multiple nodes—which may include multiple user nodes (each corresponding to a particular user) or multiple concept nodes (each corresponding to a particular concept)—and multiple edges connecting the nodes. Social-networking or AR/VR system 760 may provide users of the online social network the ability to communicate and interact with other users. In particular embodiments, users may join the online social network via social-networking or AR/VR system 760 and then add connections (e.g., relationships) to a number of other users of social-networking or AR/VR system 760 to whom they want to be connected. Herein, the term “friend” may refer to any other user of social-networking or AR/VR system 760 with whom a user has formed a connection, association, or relationship via social-networking or AR/VR system 760.

In particular embodiments, social-networking or AR/VR system 760 may provide users with the ability to take actions on various types of items or objects, supported by social-networking or AR/VR system 760. As an example and not by way of limitation, the items and objects may include groups or social networks to which users of social-networking or AR/VR system 760 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking or AR/VR system 760 or by an external system of third-party system 770, which is separate from social-networking or AR/VR system 760 and coupled to social-networking or AR/VR system 760 via a network 710.

In particular embodiments, social-networking or AR/VR system 760 may be capable of linking a variety of entities. As an example and not by way of limitation, social-networking or AR/VR system 760 may enable users to interact with each other as well as receive content from third-party systems 770 or other entities, or to allow users to interact with these entities through an application programming interfaces (API) or other communication channels.

In particular embodiments, a third-party system 770 may include one or more types of servers, one or more data stores, one or more interfaces, including but not limited to APIs, one or more web services, one or more content sources, one or more networks, or any other suitable components, e.g., that servers may communicate with. A third-party system 770 may be operated by a different entity from an entity operating social-networking or AR/VR system 760. In particular embodiments, however, social-networking or AR/VR system 760 and third-party systems 770 may operate in conjunction with each other to provide social-networking services to users of social-networking or AR/VR system 760 or third-party systems 770. In this sense, social-networking or AR/VR system 760 may provide a platform, or backbone, which other systems, such as third-party systems 770, may use to provide social-networking services and functionality to users across the Internet.

In particular embodiments, a third-party system 770 may include a third-party content object provider. A third-party content object provider may include one or more sources of content objects, which may be communicated to a client system 730. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking or AR/VR system 760 also includes user-generated content objects, which may enhance a user's interactions with social-networking or AR/VR system 760. User-generated content may include anything a user can add, upload, send, or “post” to social-networking or AR/VR system 760. As an example and not by way of limitation, a user communicates posts to social-networking or AR/VR system 760 from a client system 730. Posts may include data such as status updates or other textual data, location information, photos, videos, links, music or other similar data or media. Content may also be added to social-networking or AR/VR system 760 by a third-party through a “communication channel,” such as a newsfeed or stream.

In particular embodiments, social-networking or AR/VR system 760 may include a variety of servers, sub-systems, programs, modules, logs, and data stores. In particular embodiments, social-networking or AR/VR system 760 may include one or more of the following: a web server, a mapping server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking or AR/VR system 760 may also include suitable components such as network interfaces, security mechanisms, load balancers, failover servers, management-and-network-operations consoles, other suitable components, or any suitable combination thereof. In particular embodiments, social-networking or AR/VR system 760 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking or AR/VR system 760 to one or more client systems 730 or one or more third-party system 770 via network 710. The web server may include a mail server or other messaging functionality for receiving and routing messages between social-networking or AR/VR system 760 and one or more client systems 730. An API-request server may allow a third-party system 770 to access information from social-networking or AR/VR system 760 by calling one or more APIs. An action logger may be used to receive communications from a web server about a user's actions on or off social-networking or AR/VR system 760. In conjunction with the action log, a third-party-content-object log may be maintained of user exposures to third-party-content objects. A notification controller may provide information regarding content objects to a client system 730. Information may be pushed to a client system 730 as notifications, or information may be pulled from client system 730 responsive to a request received from client system 730. Authorization servers may be used to enforce one or more privacy settings of the users of social-networking or AR/VR system 760. A privacy setting of a user determines how particular information associated with a user can be shared. The authorization server may allow users to opt in to or opt out of having their actions logged by social-networking or AR/VR system 760 or shared with other systems (e.g., third-party system 770), such as, for example, by setting appropriate privacy settings. Third-party-content-object stores may be used to store content objects received from third parties, such as a third-party system 770. Location stores may be used for storing location information received from client systems 730 associated with users. Advertisement-pricing modules may combine social information, the current time, location information, or other suitable information to provide relevant advertisements, in the form of notifications, to a user.

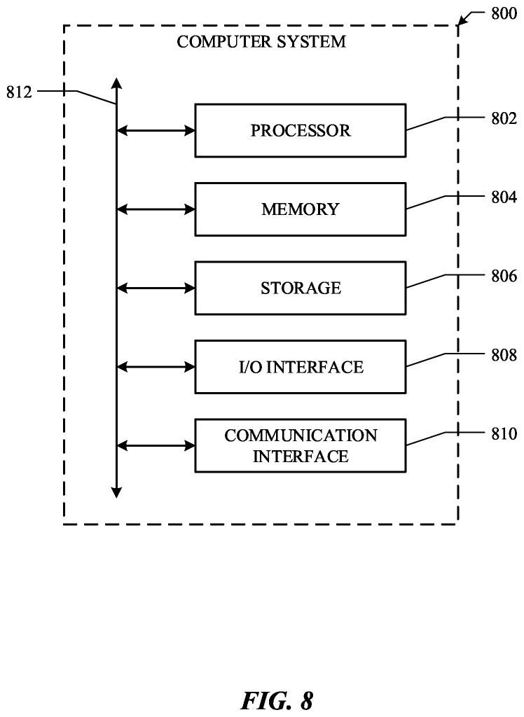

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The claims:

1. A method, implemented by a computing system, comprising:
receiving an image to be shown on a display of an artificial reality system, the display having a plurality of backlight zones;
computing a backlight matrix for adjusting brightness levels of the backlight zones of the display of the artificial reality system by:
for each of the backlight zones, computing a zone statistic to represent grayscale levels of a portion of the image within the backlight zone;
mapping the zone statistic of each of the backlight zones to a brightness value using a particular mapping technique configured to adjust any of the backlight zones having a zone statistic that is below a predetermined threshold; and
generating the backlight matrix by filtering the brightness values;
adjusting the brightness levels of the backlight zones of the display of the artificial reality system based on the backlight matrix; and
responsive to adjusting the brightness levels of the backlight zones, presenting the image on the display of the artificial reality system.

2. The method of claim 1, wherein prior to computing the zone statistic, generating a mipmap of the image, and wherein generating the mipmap of the image comprises:
downscaling the image to a reduced resolution.

3. The method of claim 1, wherein computing the zone statistic to represent the grayscale levels of the portion of the image within the backlight zone comprises:
computing, for each color component of a plurality of color components in the image, an average value of the color component across a plurality of pixels within the backlight zone; and
determining a maximum value among average values of the plurality of color components.

4. The method of claim 3, wherein the plurality of color components comprises red, green, and blue (RGB) color components.

5. The method of claim 1, wherein mapping the zone statistic of each of the backlight zones to the brightness value comprises:
determining backlight zones with zone statistics below the predetermined threshold; and
dimming the brightness levels of the determined backlight zones using the particular mapping technique.

6. The method of claim 1, wherein the predetermined threshold corresponds to low or dark grayscale levels.

7. The method of claim 1, wherein the particular mapping technique comprises a lookup table comprising predetermined brightness values corresponding to different zone statistics.

8. The method of claim 1, wherein the mapping results in an initial backlight matrix comprising of the brightness values for the backlight zones, wherein the initial backlight matrix comprises one or more artifacts.

9. The method of claim 8, wherein generating the backlight matrix by filtering the brightness values comprises:
performing spatial-temporal filtering to minimize the one or more artifacts in the initial backlight matrix.

10. The method of claim 9, wherein performing the spatial-temporal filtering to minimize the one or more artifacts in the initial backlight matrix comprises:
temporally filtering the brightness values in the initial backlight matrix based on a current frame and previous frames to minimize first artifacts; and
spatially filtering the brightness values in the initial backlight matrix based on neighboring backlight zones to minimize second artifacts.

11. The method of claim 10, wherein:
the first artifacts comprise backlight flickering artifacts due to head motion or moving objects; and
the second artifacts comprise over-dimming artifacts or halo effects.

12. The method of claim 1, wherein adjusting the brightness levels of the backlight zones of the display of the artificial-reality system comprises:
adjusting the brightness levels of the backlight zones of the display based on the brightness values in the backlight matrix.

13. The method of claim 1, wherein the brightness levels are adjusted without modifying color values of a plurality of color components in the image.

14. (canceled)

15. The method of claim 1, wherein the artificial reality system is a virtual reality headset.

16. The method of claim 1, wherein the backlight matrix is computed by an algorithm running on a central processing unit (CPU) of the artificial reality system and without needing a dedicated hardware for computing the backlight matrix.

17. One or more computer-readable non-transitory storage media embodying software that is operable when executed to:
receive an image to be shown on a display of an artificial reality system, the display having a plurality of backlight zones;
compute a backlight matrix for adjusting brightness levels of the backlight zones of the display of the artificial reality system by:
for each of the backlight zones, computing a zone statistic to represent grayscale levels of a portion of the image within the backlight zone;
mapping the zone statistic of each of the backlight zones to a brightness value using a particular mapping technique configured to adjust any of the backlight zones having a zone statistic that is below a predetermined threshold; and
generating the backlight matrix by filtering the brightness values;
adjust the brightness levels of the backlight zones of the display of the artificial reality system based on the backlight matrix; and
responsive to adjusting the brightness levels of the backlight zones, present the image on the display of the artificial reality system.

18. The media of claim 17, wherein prior to computing the zone statistic, the software is further operable when executed to generate a mipmap of the image, and wherein generating the mipmap of the image comprises:
downscaling the image to a reduced resolution.

19. A system comprising:
one or more processors; and
one or more computer-readable non-transitory storage media coupled to one or more of the processors and comprising instructions operable when executed by one or more of the processors to cause the system to:
receive an image to be shown on a display of an artificial reality system, the display having a plurality of backlight zones;
compute a backlight matrix for adjusting brightness levels of the backlight zones of the display of the artificial reality system by:
for each of the backlight zones, computing a zone statistic to represent grayscale levels of a portion of the image within the backlight zone;
mapping the zone statistic of each of the backlight zones to a brightness value using a particular mapping technique configured to adjust any of the backlight zones having a zone statistic that is below a predetermined threshold; and
generating the backlight matrix by filtering the brightness values;
adjust the brightness levels of the backlight zones of the display of the artificial reality system based on the backlight matrix; and
responsive to adjusting the brightness levels of the backlight zones, present the image on the display of the artificial reality system.

20. The system of claim 19, wherein prior to computing the zone statistic, the one or more processors are further operable when executing the instructions to cause the system to generate a mipmap of the image, and wherein generating the mipmap of the image comprises:
downscaling the image to a reduced resolution.

21. The method of claim 2, wherein the downscaling of the image is based on at least a number of backlight zones of the display of the artificial reality system.
